(19) United States
(12) Patent Application Publication
(10) Pub. No.: US 2024/0403886 A1
(43) Pub. Date: Dec. 5, 2024

(54) INFORMATION PROCESSING METHOD

(71) Applicant: TOYOTA JIDOSHA KABUSHIKI KAISHA, Aichi-ken (JP)

(72) Inventors: Sho OTAKI, Yokohama-shi (JP); Megumi MIURA, Nagareyama-shi (JP); Tetsuya SAKAI, Tokyo-to (JP); Kazuto KONISHI, Tokyo-to (JP)

(21) Appl. No.: 18/732,635

(22) Filed: Jun. 4, 2024

(30) Foreign Application Priority Data
Jun. 5, 2023 (JP) 2023-092748

(51) Int. Cl. G06Q 20/40; B60W 50/14; B60W 60/00

(52) U.S. Cl. CPC G06Q 20/407; B60W 50/14; B60W 60/0025

(57) ABSTRACT

An information processing method performed by an information processing apparatus, the information processing apparatus including a controller, a communication interface, and a memory, and being capable of communicating with a network via the communication interface, the information processing method including identifying, by the controller, a target area to open a store in the memory, acquiring, by the controller, penetration rate information indicating respective penetration rates of settlement means in the target area to open a store from the memory, and dispatching, by the controller, upon determining that a penetration rate of a first settlement means is equal to or less than a first predetermined value based on the penetration rate information, a vehicle of a provider that accepts the first settlement means to the target area to open a store.

### CROSS-REFERENCE TO RELATED APPLICATION

This application claims priority to Japanese Patent Application No. 2023-092748, filed on Jun. 5, 2023, the entire contents of which are incorporated herein by reference.

### TECHNICAL FIELD

The present disclosure relates to an information processing method.

### BACKGROUND

A settlement system that is used in a mobile store and that grants points with a high percentage to users who use face recognition settlement is known. For example, see Patent Literature (PTL) 1.

### CITATION LIST

### Patent Literature

PTL 1: JP 2014-203215 A

### SUMMARY

In the above background technology, there is no reference to the penetration rates of settlement means and there is room for improvement.

It would be helpful to assist in increasing the penetration rate of a specific settlement means.

An information processing method according to an embodiment of the present disclosure is an information processing method performed by an information processing apparatus, the information processing apparatus including a controller, a communication interface, and a memory, and being capable of communicating with a network via the communication interface, the information processing method including:
identifying, by the controller, a target area to open a store in the memory;
acquiring, by the controller, penetration rate information indicating respective penetration rates of settlement means in the target area to open a store from the memory; and
dispatching, by the controller, upon determining that a penetration rate of a first settlement means is equal to or less than a first predetermined value based on the penetration rate information, a vehicle of a provider that accepts the first settlement means to the target area to open a store.

According to an embodiment of the present disclosure, an increase in the penetration rate of a specific settlement means can be assisted.

### BRIEF DESCRIPTION OF THE DRAWINGS

In the accompanying drawings:

FIG. 1 is a schematic diagram of an information processing system according to the present embodiment;

FIG. 2 is a block diagram illustrating a configuration of an information processing apparatus;

FIG. 3 is a flowchart illustrating operations of the information processing apparatus;

FIG. 4 is a diagram illustrating a data structure of a penetration rate information database (DB); and

FIG. 5 is a diagram illustrating a data structure of a settlement means DB.

### DETAILED DESCRIPTION

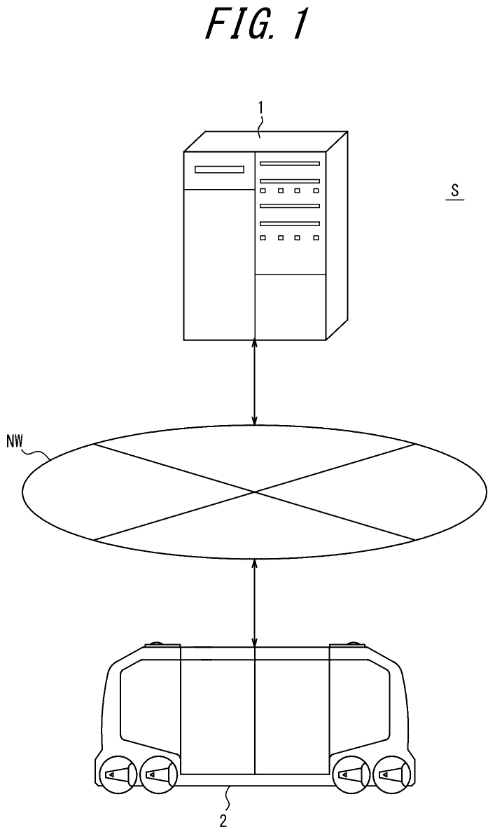

FIG. 1 is a schematic diagram of an information processing system S according to the present embodiment. The information processing system S includes an information processing apparatus 1 and a vehicle 2, which are communicably connected to each other via a network NW. The network NW includes, for example, a mobile communication network, the Internet, or a fixed communication network.

FIG. 1 illustrates one of the information processing apparatus 1 and one of the vehicle 2, for convenience of explanation. However, the number of information processing apparatuses 1 and the number of vehicles 2 are not limited to one. For example, processing to be executed by the information processing apparatus 1 may be executed by a plurality of distributed information processing apparatuses 1. The information processing apparatus 1 may be capable of communicating with a plurality of vehicles 2. The plurality of vehicles 2 may be connected to the network NW.

The information processing apparatus 1 may be a server configured to assist a provider in providing a service. The information processing apparatus 1 may be, for example, installed in a facility dedicated to the provider or in a shared facility including a data center. As an alternative example, the information processing apparatus 1 may be mounted in the vehicle 2. The information processing apparatus 1 may be referred to as a center server or a roll call system.

The vehicle 2 includes, for example, any type of automobile such as a gasoline vehicle, a diesel vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The driving of the vehicle 2 may be automated at any level. The automation level is, for example, any one of Level 1 to Level 5 according to the level classification defined by SAE. The name “SAE” is an abbreviation of Society of Automotive Engineers. The vehicle 2 may be a MaaS-dedicated vehicle. The term “MaaS” is an abbreviation of Mobility as a Service. Alternatively, the vehicle 2 may be driven by a driver.

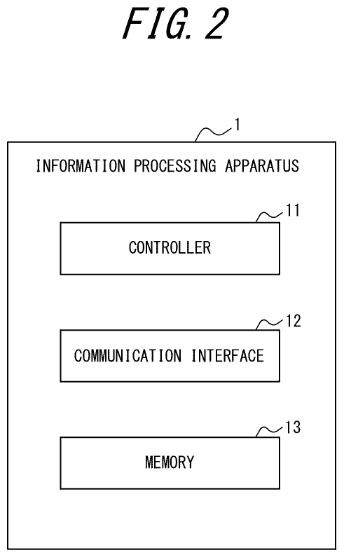

In FIG. 2, an internal configuration of the information processing apparatus 1 will be described in detail.

The information processing apparatus 1 includes a controller 11, a communication interface 12, a memory 13, and a display 14. The components of the information processing apparatus 1 are communicably connected to one another via, for example, dedicated lines.

The controller 11 includes, for example, one or more general purpose processors including a Central Processing Unit (CPU) or a Micro Processing Unit (MPU). The controller 11 may include one or more dedicated processors that are dedicated to specific processing. The controller 11 may include one or more dedicated circuits instead of the processors. Examples of the dedicated circuits may include a Field-Programmable Gate Array (FPGA) and an Application Specific Integrated Circuit (ASIC). The controller 11 may include an Electronic Control Unit (ECU). The controller 11 transmits and receives any information via the communication interface 12.

The communication interface 12 includes, for connecting to a network, one or more communication modules that conform to wired or wireless LAN (Local Area Network) standards. The communication interface 12 may include a module conforming to one or more mobile communication standards including the Long Term Evolution (LTE) standard, the 4th Generation (4G) standard, or the 5th Generation (5G) standard. The communication interface 12 may include one or more communication modules conforming to near field communication standards or specifications, including Bluetooth® (Bluetooth is a registered trademark in Japan, other countries, or both), AirDrop® (AirDrop is a registered trademark in Japan, other countries, or both), IrDA, ZigBee® (ZigBee is a registered trademark in Japan, other countries, or both), Felica® (Felica is a registered trademark in Japan, other countries, or both), or RFID. The communication interface 12 transmits and receives any information via the network.

The memory 13 includes, for example, a semiconductor memory, a magnetic memory, an optical memory, or a combination of at least two of these, but is not limited to these. The semiconductor memory is, for example, RAM or ROM. The RAM is, for example, SRAM or DRAM. The ROM is, for example, EEPROM. The memory 13 may function as, for example, a main memory, an auxiliary memory, or a cache memory. The memory 13 may store information resulting from analysis or processing performed by the controller 11. The memory 13 may store various types of information or the like regarding operations and control of the information processing apparatus 1. The memory 13 may store a system program, an application program, embedded software, and the like. The memory 13 may be provided outside the information processing apparatus 1 and accessed by the information processing apparatus 1. The memory 13 includes a penetration rate information DB and a settlement means DB.

Hereinafter, an information processing method executed by the information processing system S according to the present embodiment will be described in detail. As an example here, the vehicle 2 is used by a provider. The business is a restaurant, for example. The vehicle 2 is mobile and provides goods or services as a store in the target area to open a store.

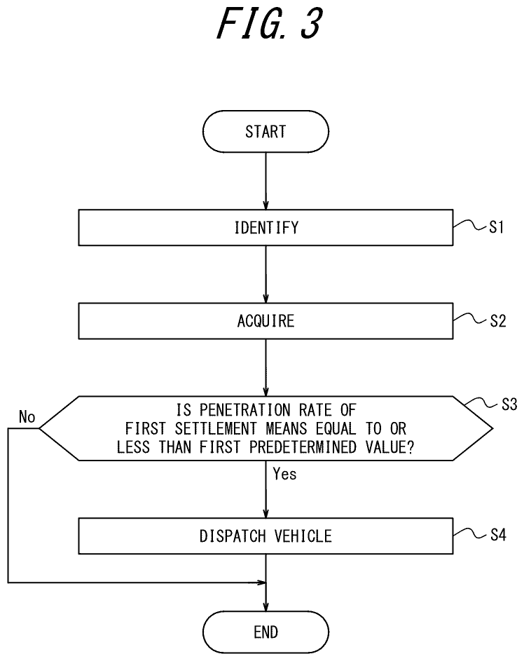

In S1 of FIG. 3, the controller 11 of the information processing apparatus 1 identifies the target area to open a store by referring to the memory 13. The target area to open a store is specified by the user.

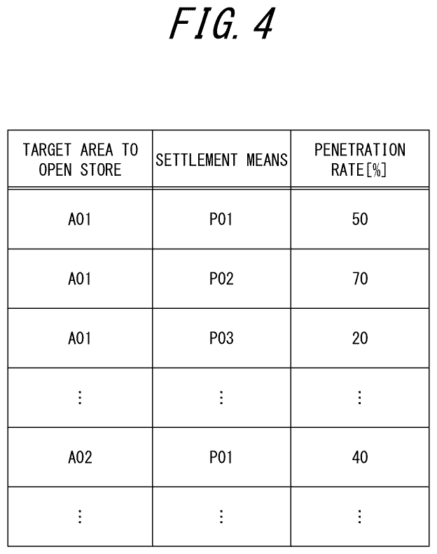

In S2, the controller 11 acquires from the memory 13 the penetration rate information indicating respective penetration rates of settlement means in the target area to open a store. As illustrated in FIG. 4, the respective penetration rates of settlement means are stored in the penetration rate information DB in association with the target area to open a store.

The settlement means is provided by the settlement provider. Each provider may have a different settlement provider to contract with. The settlement means may be, for example, electronic money, two-dimensional code, credit card, debit card, or cryptographic asset. The provider, the owner of the vehicle 2, and the settlement provider may be separate. The provider, the owner of the vehicle 2 and the payment provider may be combined and stored by the information processing apparatus 1 in the memory 13.

In S3, the controller 11 determines whether the penetration rate of the first settlement means is equal to or less than the first predetermined value from the acquired penetration rate information. The first settlement means may be specified by the user or set arbitrarily by the information processing apparatus 1. The first predetermined value can be set to any value.

If No in S3, the controller 11 does not perform S4.

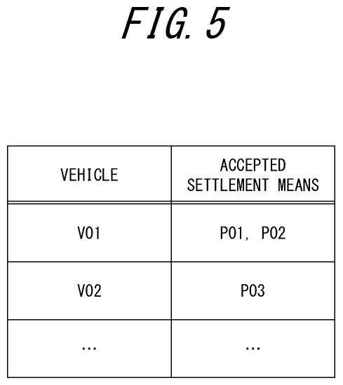

As illustrated in FIG. 5, in the settlement means DB, for each vehicle 2, the settlement means the provider of the vehicle 2 accepts are associated and stored. If Yes in S3, the controller 11 identifies the vehicle of the provider that accepts the first settlement means in S4, and dispatches the identified vehicle 2 to the target area to open a store. The controller 11 may control the vehicle 2, an automated vehicle, to move it to the target area to open a store, or it may instruct the user to move the vehicle 2 to the target area to open a store.

As an additional or alternative example, the controller 11 may increase, in the memory 13, the refund rate for a case in which the first settlement means is used in the vehicle 2 upon determining that the penetration rate of the first settlement means is equal to or less than a second predetermined value that is even lower than the first predetermined value. A refund indicates returning some or all of the funds paid by the user using the first settlement means to the same user. The refund may be referred to as a cash refund.

As an additional or alternative example, the controller 11 may detect the first settlement means that can be used by the user (here the customer). The settlement means that can be used by the user may be detected in the memory 13 or by the terminal operated by the user. The controller 11 may notify, upon determining that the first settlement means, which is eligible for a refund, is not included among the settlement means that can be used, the user of the first settlement means, which is eligible for the refund, via an output interface of the vehicle 2. The output interface of the vehicle 2 may be, for example, a speaker or a display.

As an additional or alternative example, the controller 11 may dispatch in S4 a vehicle 2 capable of notification of a method of using or registering the first settlement means, which is eligible for a refund. The notification may be made via the output interface in the vehicle 2.

As described above, according to the present embodiment, the operation of the controller 11 includes identifying the target area to open a store in the memory 13, acquiring the penetration rate information indicating the respective penetration rates of the settlement means in the target area to open a store from the memory 13, and dispatching, upon determining that the penetration rate of the first settlement means is equal to or less than the first predetermined value based on the penetration rate information, the vehicle 2 of the provider that accepts the first settlement means to the target area to open a store. This configuration allows the information processing apparatus 1 to assist the increase in the penetration rate of a specific settlement means in the target area to open a store.

According to the present embodiment, the operation of the controller 11 also includes increasing, in the memory 13, the refund rate for a case in which the first settlement means is used in the vehicle 2 upon determining that the penetration rate of the first settlement means is equal to or less than a second predetermined value that is lower than the first predetermined value. This configuration allows the information processing apparatus 1 to provide the user with motivation to use the first settlement means.

According to the present embodiment, the operation of the controller 11 also includes detecting the settlement means that can be used by the user in the memory 13 and notifying, upon determining that the first settlement means, which is eligible for the refund, is not included among the settlement means that can be used, the user of the first settlement means, which is eligible for the refund, via the output interface of the vehicle 2. This configuration allows the information processing apparatus 1 to provide the user with motivation to use the first settlement means.

According to the present embodiment, the operation of the controller 11 also includes dispatching a vehicle 2 capable of notification of a method of using or registering the first settlement means, which is eligible for the refund. This configuration allows the information processing apparatus 1 to assist the use of the first settlement means.

While the present disclosure has been described with reference to the drawings and examples, it should be noted that various modifications and revisions may be implemented by those skilled in the art based on the present disclosure. Other modifications can be made without departing from the spirit of the present disclosure. For example, functions or the like included in each means or each step can be rearranged without logical inconsistency, and a plurality of means or steps can be combined into one or divided.

For example, in the above embodiment, a program that executes all or some of the functions or processing of the information processing apparatus 1 and the vehicle 2 can be recorded on a computer readable recording medium. The computer readable recording medium includes a non-transitory computer readable medium and is, for example, a magnetic recording apparatus, an optical disc, a magneto-optical recording medium, or a semiconductor memory. The program is distributed, for example, by selling, transferring, or lending a portable recording medium such as a Digital Versatile Disc (DVD) or a Compact Disc Read Only Memory (CD-ROM) on which the program is recorded. The program may also be distributed by storing the program in a storage of any server and transmitting the program from any server to another computer. The program may be provided as a program product. The present disclosure can also be implemented as a program executable by a processor.

A computer temporarily stores in a main memory, for example, the program recorded on the portable recording medium, or the program transferred from the server. Then, the computer reads the program stored in the main memory using a processor, and executes processes in accordance with the read program using the processor. The computer may read the program directly from the portable recording medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. The program encompasses information that is to be used for processing by an electronic computer and is thus equivalent to a program. For example, data that is not a direct command to a computer but has a property that regulates processing of the computer is “equivalent to a program” in this context.

1. An information processing method performed by an information processing apparatus, the information processing apparatus comprising a controller, a communication interface, and a memory, and being capable of communicating with a network via the communication interface, the information processing method comprising:
identifying, by the controller, a target area to open a store in the memory;
acquiring, by the controller, penetration rate information indicating respective penetration rates of settlement means in the target area to open a store from the memory; and
dispatching, by the controller, upon determining that a penetration rate of a first settlement means is equal to or less than a first predetermined value based on the penetration rate information, a vehicle of a provider that accepts the first settlement means to the target area to open a store.

2. The information processing method according to claim 1, further comprising increasing, in the memory, a refund rate for a case in which the first settlement means is used in the vehicle upon determining that the penetration rate of the first settlement means is equal to or less than a second predetermined value that is lower than the first predetermined value.

3. The information processing method according to claim 2, further comprising:
detecting settlement means that can be used by a user in the memory; and
notifying, upon determining that the first settlement means, which is eligible for a refund, is not included among the settlement means that can be used, the user of the first settlement means, which is eligible for the refund, via an output interface of the vehicle.

4. The information processing method according to claim 2, further comprising dispatching a vehicle capable of notification of a method of using or registering the first settlement means, which is eligible for a refund.
